(19) United States
(12) Patent Application Publication
(10) Pub. No.: US 2008/0294673 A1
(43) Pub. Date: Nov. 27, 2008

(54) DATA TRANSFER AND STORAGE BASED ON META-DATA

(75) Inventors: Adrian Rupp, Bothell, WA (US); Ullas Kumble, Kirkland, WA (US); Saurabh Jain, Redmond, WA (US); Andrey Shishkarev, Sammamish, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/753,969

(22) Filed: May 25, 2007

(51) Int. Cl. G06F 17/30

(52) U.S. Cl. 707/102; 707/E17.005

(57) ABSTRACT

Meta-data is used to generate code which retrieves source data from multiple sources having different formats and places the data into a set of tables having a single schema. Stored procedures access meta-data from a set of meta-data tables, configure one or more destination tables, generate query code from the meta-data and store the source data in the destination tables. When storing the data, data may be replaced or updated as part of storing the source data. The meta-data tables contain meta-data that is combined into code statements by the stored procedures. The code statements are used to retrieve source data from one or more source data stores. Destination tables for storing retrieved data may have a single schema for storing source data, wherein the source data includes several different domains having different numbers of levels and attributes and originates from more than one source.

### BACKGROUND

Forecasting systems are important to planning future business strategy, resource deployment, and other business objectives. Forecasting data is typically accessed from several sources, stored, and analyzed to perform forecasting. For example, forecasting source data may involve enterprise hierarchy systems built by entities that differ each other as well as those doing the forecasting. Thus, forecasting source data is often stored in several formats.

Most forecasting systems are designed for a specific set of source data, and store source data in a large number of tables, such as hundreds of tables. The forecasting system is usually hard coded to address specific features of the particular forecasting source data. To make changes to the forecasting system requires significant time and resources to change the underlying code of the system. For example, changing a typical forecasting system would require a change in reporting system code, a new executable file, or other significant and time-consuming changes to the system.

### SUMMARY

The technology described herein pertains to retrieving source data from multiple sources, each having potentially different formats, and placing the data into a set of tables having a single schema. Stored procedures access meta-data from a set of meta-data tables and generate query code from the meta-data. The query code is used to access the source data. The stored procedures and/or other logic may also configure one or more destination tables and store the source data in the destination tables. When storing the data, the logic may replace or update existing data as part of storing the source data.

The system accesses source data and stores the data using meta-data tables, destination tables and one or more stored procedures. The meta-data tables contain meta-data that is combined into code statements by the stored procedures. The code statements are used to retrieve source data from one or more source data stores. In some embodiments, the meta-data is concatenated into transact-SQL code statements to query SQL servers for source data. Destination tables contain data retrieved from the one or more source data stores by the generated code statements. The destination tables may have a single schema for storing source data describing several different domains, having different numbers of levels and attributes, and originating from more than one source.

An embodiment may comprise a method which accesses meta-data that describes remote source data. Query code may then be dynamically generated by combining the accessed meta-data and executed. The query code may be executed to retrieve remote source data stored in a first format at a remote data store. The retrieved source data may then be stored in a set of destination tables having a second format. The second format may be based on a set of domain records, a set of member records for each domain record, and attributes for each domain record and member record.

One embodiment may include an apparatus for transferring data which includes a communication interface, a storage device and one or more processors. The storage device may contain one or more meta-data tables having meta-data that describes domain, member, member mapping and attribute data. The one or more processors may be in communication with the storage device and communication interface and implement a data engine. The data engine may build transact-SQL (TSQL) statements based on the meta-data in said meta-data tables. The TSQL statements may be built for accessing remote source data and store the accessed source data in one or more destination tables.

An embodiment may access meta-data which describes remote source data at a first data store having a first schema and a second data store having a second schema. A data engine may dynamically generate code statements by combining the accessed meta-data. The code statements may then be executed to retrieve the remote source data from the first data store and the second data store. The two or more destination tables may be updated based on whether the retrieved source data is different from data in the destination tables. Updating the destination tables may include storing the retrieved source data from the first data store and the second data store in the two or more destination tables. The two or more destination tables may have a third schema based domain records, member records for each domain record, and attributes for each domain record and member record.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram of an embodiment of a system for transferring data to an operational data store.

FIG. 1B is an example of a schema for meta-data tables.

FIG. 1C is an example of a schema for destination tables.

FIG. 2 is a block diagram of a computing environment for implementing the present technology.

FIG. 3 is a flowchart of an embodiment of a method for transferring data from a data source to an operational data store.

FIG. 4 is a flowchart of an embodiment of a method for configuring a domain table.

FIG. 5 is a flowchart of an embodiment of a method for configuring a domain attribute table.

FIG. 6 is a flowchart of an embodiment of a method for updating a domain table with retrieved domain data.

FIG. 7 is a flowchart of an embodiment of a method for updating a domain attribute table with retrieved domain attribute data.

FIG. 8 is a flowchart of an embodiment of a method for updating member and member attribute data.

FIG. 9 is a flowchart of an embodiment of a method for mapping relationships between members.

FIG. 10A is an example of source data tables.

FIG. 10B is an example of meta-data tables.

FIG. 10C is an example of destination data tables.

### DETAILED DESCRIPTION

Data from multiple sources having different formats can be retrieved and placed into a set of tables having a single schema. Code for retrieving the data can be dynamically generated from meta-data. Stored procedures access meta-data from a set of meta-data tables and generate code for configuring one or more destination tables, retrieving the source data, and storing the source data in the destination tables. When storing the data, existing data may be replaced or updated as part of the storing of data.

Meta-data tables contain meta-data used to extract source data. The meta-data may be concatenated together to form code and/or query statements for retrieving the data from a data store. In some embodiments, the meta-data is concatenated into transact-SQL code statements to query SQL servers for source data. The meta-data tables may retrieve data for source data domains, domain levels and attributes, mapping data and mapping attributes. Additional logic of the system may handle processing of the data retrieved by the meta-data based code, including placing the code within one or more destination tables.

Destination tables contain data retrieved from one or more sources by code generated from meta-data. The destination tables may have a single schema for storing source data describing several different domains, having different numbers of levels and attributes, and originating from more than one source. In some embodiments, the destination tables may be comprised of three main data tables and three attribute tables. The three main data tables may include tables for domain data records, member data records and member map data. The corresponding attribute tables may contain attribute data for the domain records, member records and member map data, respectively.

In some embodiments, one or more stored procedures can generate code for querying a data source from meta-data contained in the meta-data tables. The retrieved code may be placed in the destination tables by additional code generated by the stored procedures, the stored procedures themselves, or other logic. In some embodiments, the stored procedures generate transact-SQL (TSQL) code to query one or more data sources described by the meta-data.

The source data accessed by the TSQL code may contain forecasting data. For example, the source data may include data in one or more different domains that include different types of attributes, are stored in different formats or schemas, and are located on different machines in different places. In some embodiments, the source data may be stored by several different Enterprise hierarchy systems that were built by different groups and have different formats. The meta-data contained in the meta-data tables may describe the data to retrieve from the different source data. Once the different source data is retrieved, it is placed in the same set of destination tables. The data in the destination tables may then be scaled, summarized, or otherwise processed to provide forecasting based on the retrieved data.

By generating TSQL code dynamically from meta-data contained in accessible meta-data tables, code to access different types of enterprise hierarchy system data is written only once. The code used to query each system will be potentially different based on the different meta-data contained in the meta-data tables. This allows for a flexible, scalable data-retrieval system which may access data from several sources having different formats and store the data in a single set of tables having a single schema, rather than one or more tables that have schemas that match each enterprise hierarchy system.

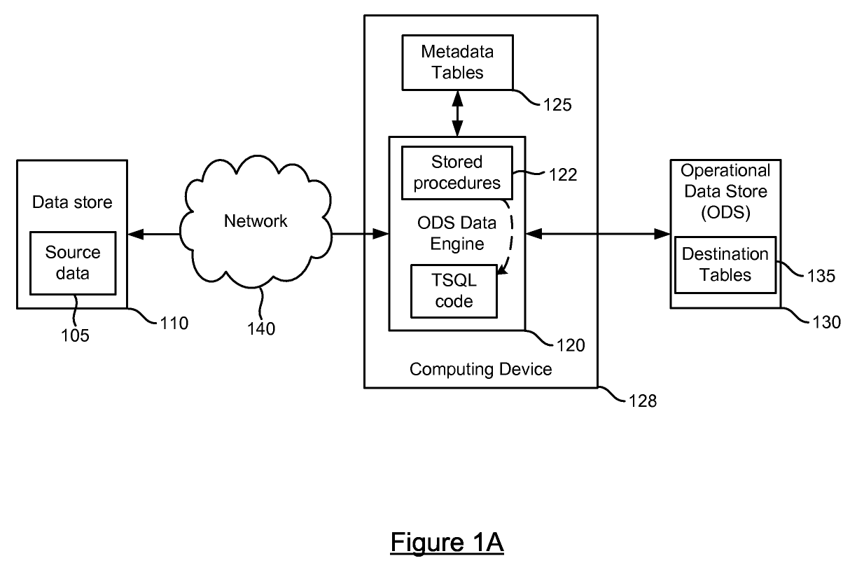

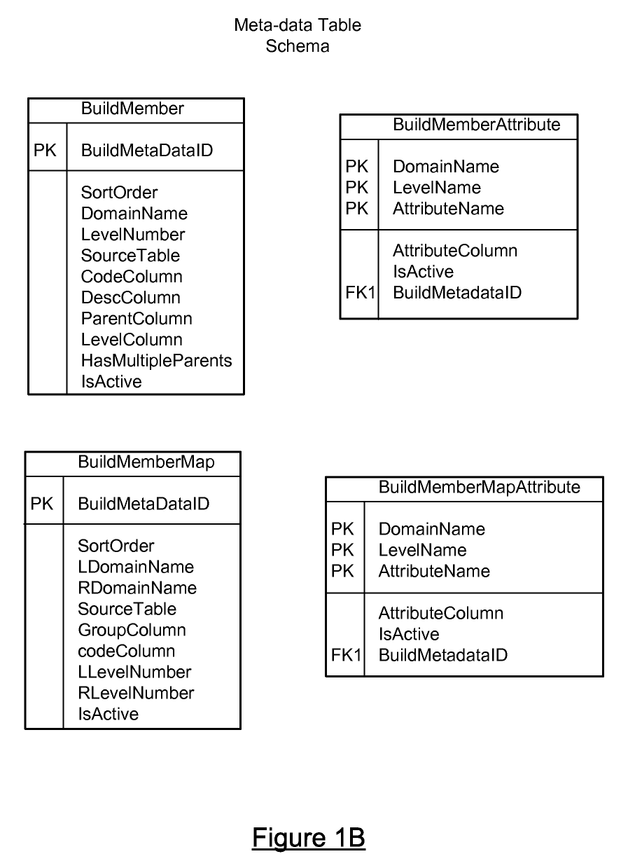

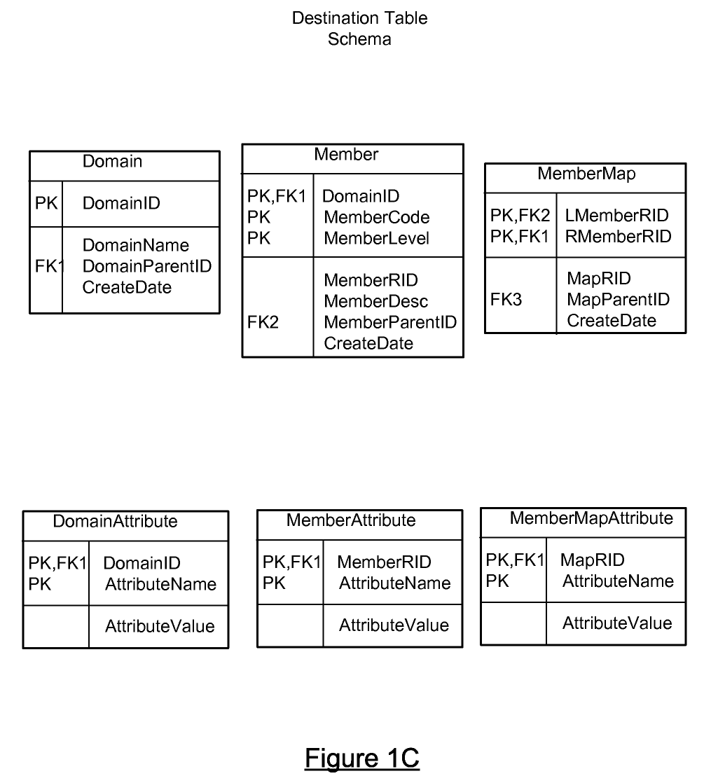

FIG. 1A is a block diagram of an embodiment of a system for transferring data to an operational data store. The system of FIG. 1A includes data store 110, operational data store data engine 120, computing device 128, operational data store (ODS) 130, and network 140. Network 140 may be implemented as the internet, an intranet, or some other public or private network.

Data store 110 may include source data 105. Source data 105 may include enterprise dimension data and available to be extracted from data source 110. Once extracted, source data 105 from data store 110 or some other source may be stored in a set of tables having a single schema structure, such as destination tables 135. Data store 110 may be implemented as an SQL server or some other type of server, and may communicate with computing device 128 over network 140.

Computing device 128 may include ODS data engine 120 and meta-data tables 125 and communicate with data store 110 over network 140 and operational data store 130. ODS data engine 120 may include stored procedures 122 and TSQL code 124. Stored procedures 122 may provide logic for generating code 124 from meta-data tables 125, inserting data into destination tables 135 of ODS 130, and configuring destination tables 135. In some embodiments, the generated TSQL code may configure destination tables 135, extract data from one or more external data stores, process the extracted data and update destination tables 135 in data store 130. In some embodiments, the stored procedures 122 may include a BuildAllMembers stored procedure for accessing and storing data and a BuildAllMemberMap stored procedure for generating relationships between data member records, or other data. Each of these stored procedures is discussed in more detail below. TSQL code 124 may be generated by one or more stored procedures 122 based on meta-data tables 125. Code 124 may query data store 110 and optionally update data in ODS 130.

Meta-data tables 125 may include one or more tables that describe source data located in data store 110, configuration of destination tables 135, and storage of the source data in the destination tables. In some embodiments, meta-data tables 125 can be stored externally to computing device 128. Examples of meta-data tables 125 are discussed in more detail below with respect to FIG. 1B.

Operational data store 130 may include destination tables 135. Destination tables 135 may include a set of six tables having a single schema for storing source data from one or more data stores, such as data store 110. Examples of destination tables 135 are discussed in more detail below with respect to FIG. 1C.

FIG. 1B is an example of a schema for meta-data tables. In some embodiments, the schema of FIG. 1B provides more detail for meta-data tables 125 of FIG. 1A. The table schema of FIG. 1B includes schema for a BuildMember Table, BuildMemberAttribute table, BuildMemberMap table and BuildMemberMap Attribute table. The BuildMember table holds meta-data needed to extract data (such as dimension data) from data stores such as data store 110. The meta-data may be combined at execution time to generate dynamic TSQL code for importing data into ODS 130, and is used to insert, update and delete data in ODS 130.

The schema for the BuildMember table describes several columns of data. The build member ID data (or build meta-data ID) is an autoincremental integer which may also be used as the foreign key for the build member attribute table. The sort order data defines the order in which the meta-data executes. For example, a set of data may have dependencies where only one level needs to be inserted prior to a lower level so that the member parent ID may be looked up. The sort order has a numerical value for each build member ID table.

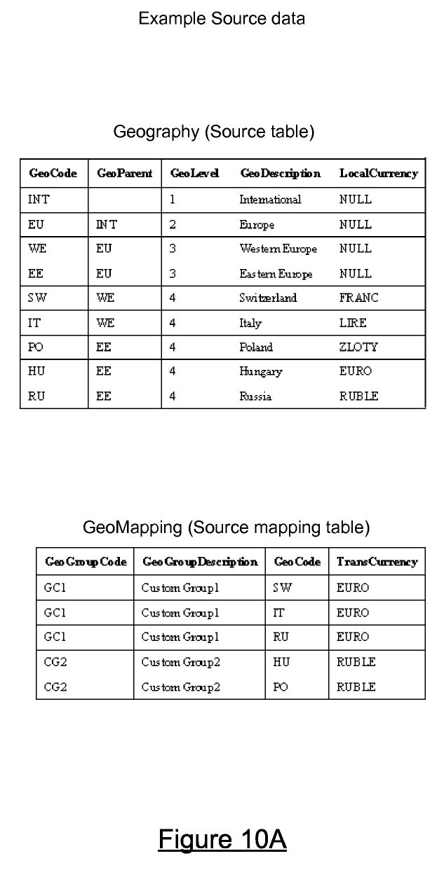

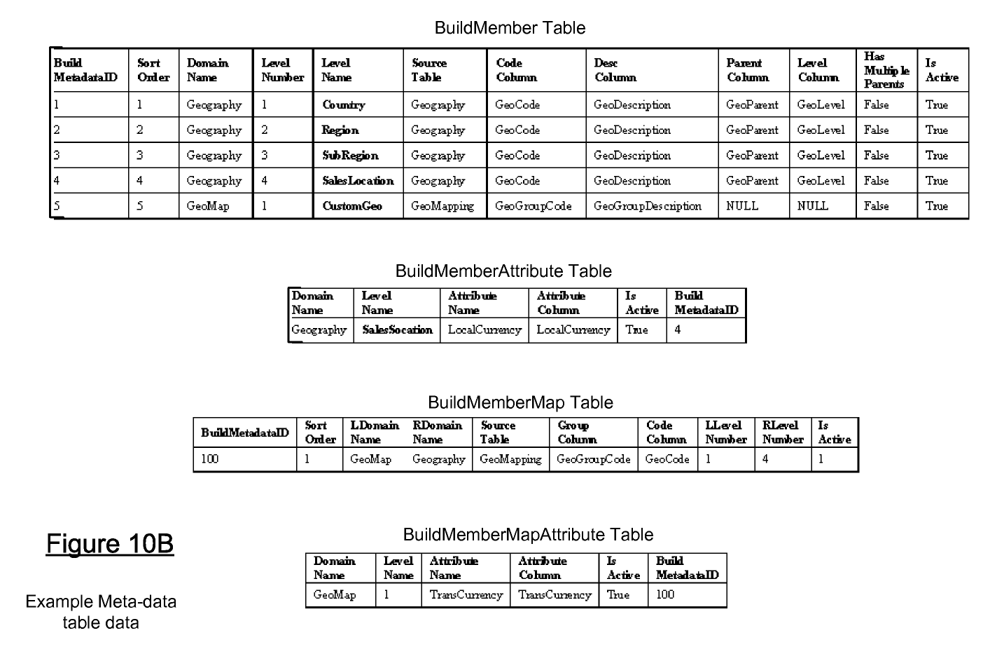

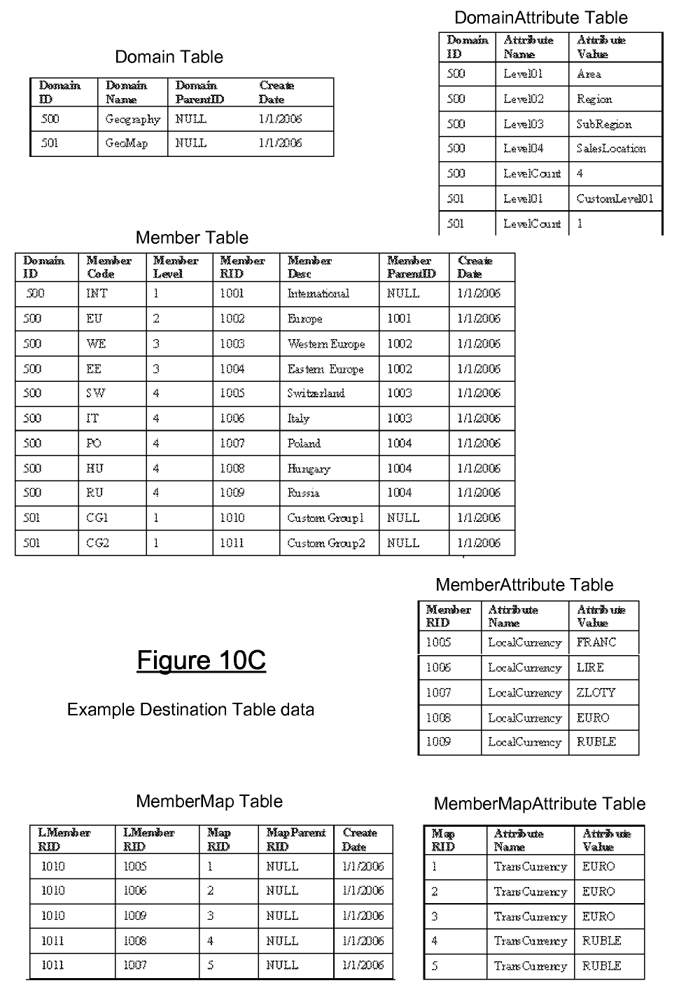

The domain name data of the BuildMemberMetadata table defines a domain name to identify the data to extract from source data 105. The level name data describes the name of a domain level. For hierarchical data, the level name identifies the level of the hierarchy. For example, for a domain of geography as illustrated in the BuildMember table of FIG. 10B, a level 1 may be a country, a level 2 may be a state and a level 3 may be a city. The level member defined for level number as an integer when inserted into the member table. The source table column of the schema contains dynamic TSQL used in the stored procedure to define the source of the data. The information stored in this column could follow a three or four part naming convention, for example, a four part naming convention of server.database.schema.table. In some embodiments, other formats may be used as well. The code column data may include dynamic TSQL to define what data column of the source data should be used for the code of the dimension. The description (“desc”) column data may include dynamic TSQL to define what data column should be used for the description as the member record. The parent column and level column data of the build member meta-data table are optional. The parent column data includes dynamic TSQL which is used to define what data column should be used for the parent of the dimension record if the dimension is hierarchical in nature. The level column defines the level of the data and its dynamic TSQL used to select the data.

The Has Multiple Parents data is a field which eliminates or skips over the dynamic TSQL to insert the parent value if the data has a many to one relationship (i.e., has many parents). The IsActive data is a field which optionally activates or deactivates the meta-data. Deactivating the record will skip this in the dynamic execution and thus will be filtered out.

The BuildMemberAttribute table has data columns of domain name, level name, attribute name, attribute column, is active, and build meta-data ID, in addition to other columns. The build member ID date is a foreign key to the build member tables and is used to link attribute meta-data with the parent record. Domain name data is used in building dynamic TSQL for generating inserts and update statements to populate attribute data in RDS. Level name data defines the level of the hierarchy that is inserted into the member table. An attribute name is a user defined column used to identify an attribute. The attribute column data includes TSQL used to define what data should be used for the attribute of the record. IsActive is used to activate or deactivate the meta-data.

The BuildMemberMap table includes data columns of build meta-data ID, sort order, left domain name, right domain name, source table, group column, code column, left level member, right level member and is active. The build meta-data ID column is used as a foreign key for the build member map attribute table. The sort order column defines the order in which meta-data may execute. The left domain name column defines the domain name to identify for the left side data that is to be extracted from the source. This is normally the custom group number, but not always. In some embodiments, an actual name of a domain may be used for readability and the domain ID is looked up from the domain table of the ODS data store. Right domain name defines the domain name for the right side of a custom grouping and, in some embodiments, may be the many part of a one to many relationship (for example, when one member is mapped to several members). The source data column may contain dynamic TSQL used in the stored procedure to define the source of the data for the left or custom group members. Group column data may include TSQL used to define what data column of the source should be used for the custom group member record. Code column data may be dynamic TSQL used to define what data column of the source should be used for the code of the dimension. Left level member maps data to a specific member level for the custom group records. Right level member maps data to a specific member level for the right side or many records. IsActive is an attribute which optionally deactivates member map records.

The BuildMemberMapAttribute table includes columns of domain name, level name, attribute name, attribute column, is active and build meta-data ID. The meaning and use of the columns of the build member map attributes are similar to those discussed above for the other meta-data table schemas, but with respect to the BuildMemberMap table.

FIG. 1C is an example of a schema for a set of destination tables. In some embodiments, the schema of FIG. 1C provides more detail for destination tables 135 of FIG. 1A. The schema of the destination tables is implemented as six different tables. The tables include a domain table, a member table and a member map table. Each of these three tables is associated with an attribute table, namely a domain attribute table, member attribute table, and member map attribute table. A domain record may have several member records. Each domain is described by data contained in the domain table. Each member record of a domain record is described by data contained in the member table. Two or more member records may be mapped together. The mapped relationship between two members may be described in the member map table.

The domain table includes columns of domain ID, domain name, domain parent ID and create date. The member table includes data columns of domain ID, member code, member level, member identifier, member description, member parent ID and create data. The member map table includes columns of left member ID, right member ID, map ID, map parent ID and attribute date. The domain attribute table describes attributes for domain and includes columns of domain ID, attribute name and attribute value. The member attribute table describes one or more attributes for one or more members and includes columns of member ID, attribute name and attribute value. The member map attribute table describes attributes for one or more mapped relationships and includes columns of map ID, attribute name and attribute value.

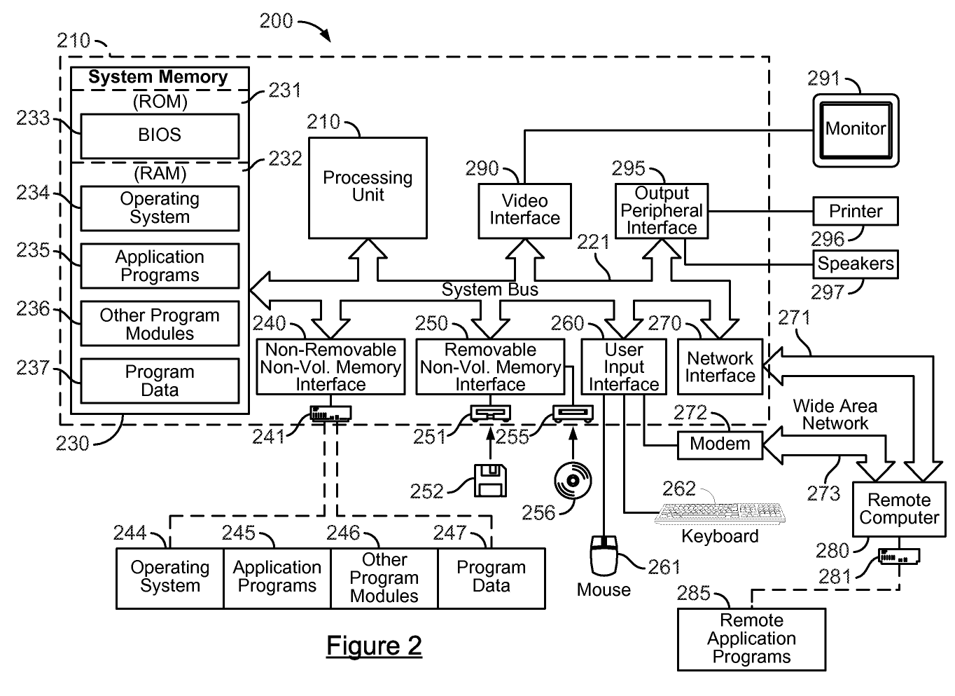

FIG. 2 is a block diagram of a computing system for implementing the present technology. In one embodiment, the computing system of FIG. 2 provides more detail for data store 105, computing device 128 and ODS 130.

FIG. 2 illustrates an example of a suitable computing system environment 200 on which the present technology may be implemented. The computing system environment 200 is only one example of a suitable computing environment and is not intended to suggest any limitation as to the scope of use or functionality of the technology. Neither should the computing environment 200 be interpreted as having any dependency or requirement relating to any one or combination of components illustrated in the exemplary operating environment 200.

The technology is operational with numerous other general purpose or special purpose computing system environments or configurations. Examples of well known computing systems, environments, and/or configurations that may be suitable for use with the technology include, but are not limited to, personal computers, server computers, hand-held or laptop devices, cell phones, smart phones, multiprocessor systems, microprocessor-based systems, set top boxes, programmable consumer electronics, network PCs, minicomputers, mainframe computers, distributed computing environments that include any of the above systems or devices, and the like.

The technology may be described in the general context of computer-executable instructions, such as program modules, being executed by a computer. Generally, program modules include routines, programs, objects, components, data structures, etc. that perform particular tasks or implement particular abstract data types. The technology may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the technology includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 290.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

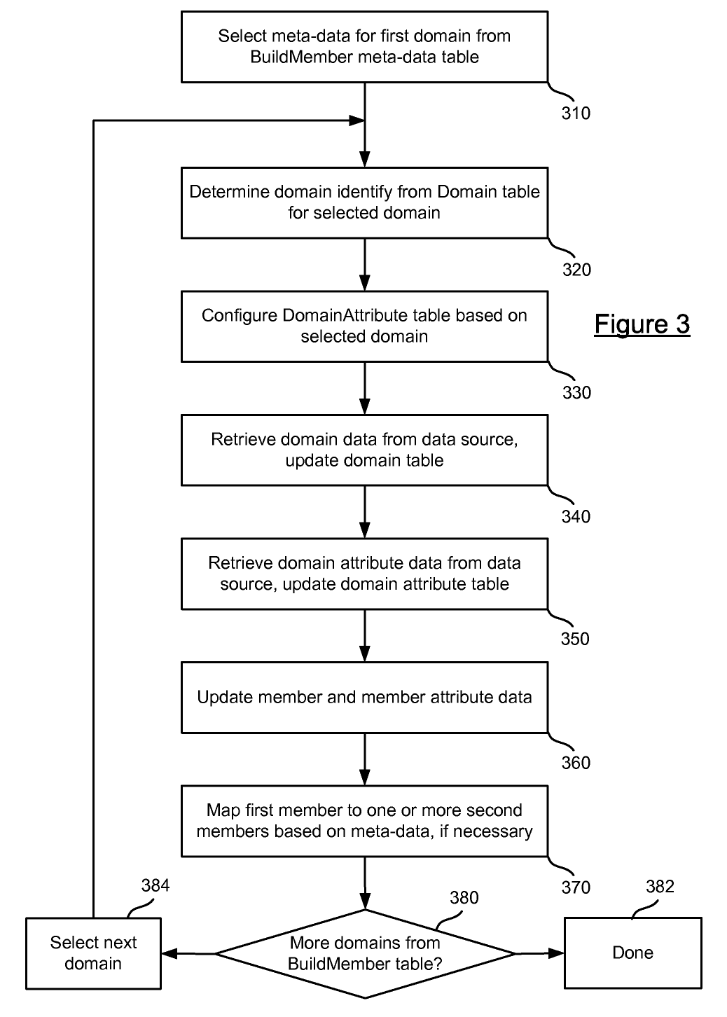

FIG. 3 is a flowchart of an embodiment of a method for transferring data from a data source to an operational data store. The method of FIG. 3 may be implemented by one or more stored procedures 122 within ODS data engine 120. Stored procedures may configure destination tables, extract source data, and update the tables with the source data. The stored procedures may also map members to each other, if necessary. Example data in FIG. 10A-C will occasionally be referenced throughout the discussion of FIGS. 3-9.

First, meta-data is selected for a first domain from the BuildMemberMetadata table at 310. Thus, the first domain listed in the BuildMember Table is selected at step 310. With respect to example meta-data tables in FIG. 10B, the first domain of the build member meta-data table is “geography.” In some embodiments, selecting meta-data may for a first domain may also include declaring variables which may be used throughout the process described by FIGS. 3-9.

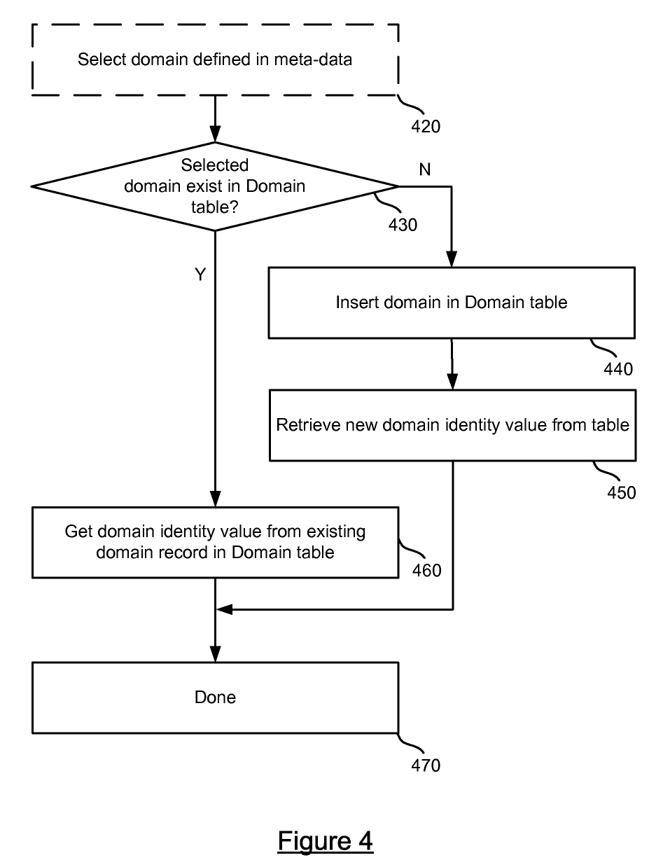

Next, the domain identity for the selected domain is determined from the Domain table of destination tables 135 at step 320. Determining the domain identity may include either inserting a new domain record into the table or reading information for an existing domain record from the table. Configuring a Domain table is discussed in more detail below with respect to FIG. 4.

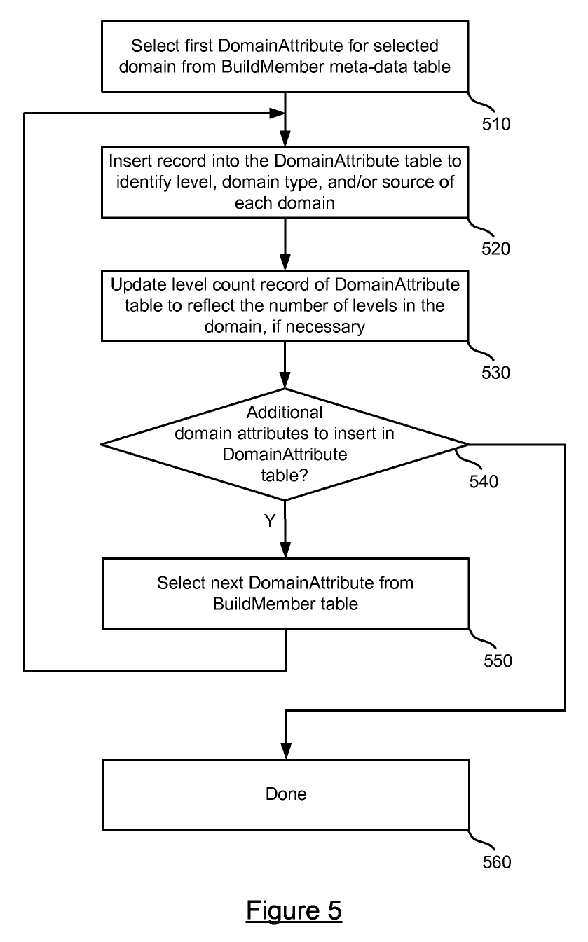

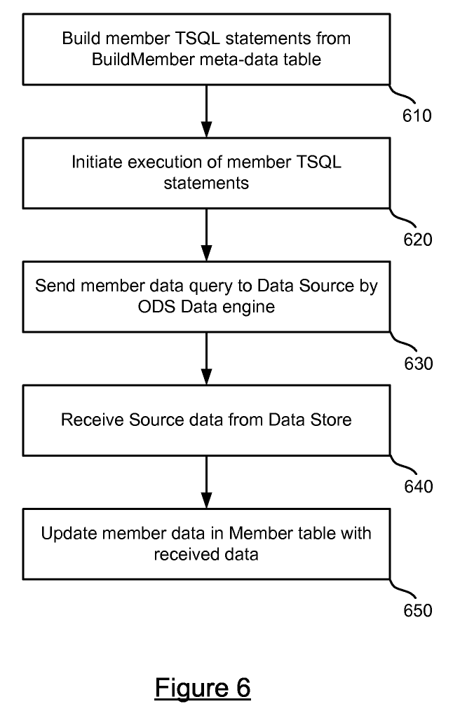

The DomainAttribute table is configured based on the selected domain at step 330. Configuring the DomainAttribute table may include inserting or confirming that domain attributes in the DomainAttribute table exists. Configuring DomainAttribute tables based on the selected domain is discussed in more detail below with respect to the method of FIG. 5. Domain data is then retrieved from a data source and updated in the domain table at step 340. Retrieving domain data from a data source may include generating TSQL code, executing the TSQL code to query data store 110 for the source data and load extracted data into one or more destination tables 135. Retrieving domain data and updating a domain table is discussed in more detail below with respect to FIG. 6.

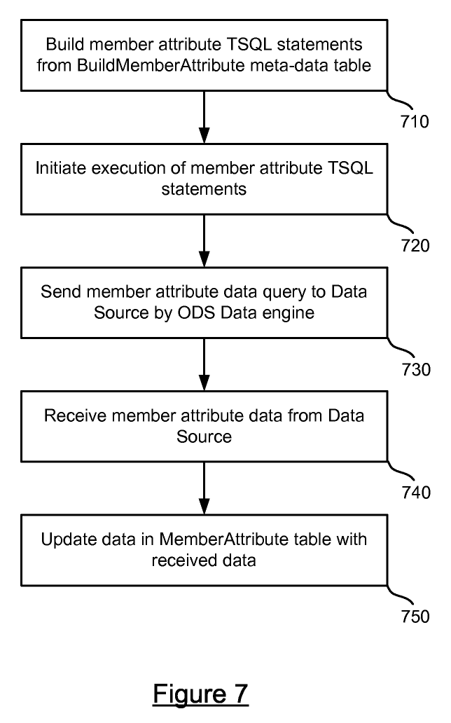

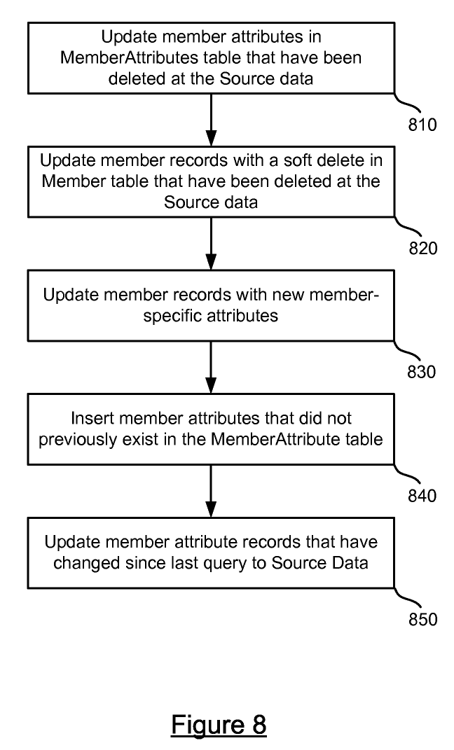

Domain attribute data is then retrieved from data store 110 and placed in DomainAttribute tables at step 350. The domain attribute data can be retrieved from several data sources, including as data store 110. Retrieving domain attribute data and updating the domain attribute table may include generating TSQL code from meta-data in meta-data tables 125, querying data stores having domain attribute data using the TSQL code and placing the data retrieved from the query in one or more destination tables 135. Retrieving domain attribute data and updating domain attribute tables is discussed in more detail below with respect to FIG. 7. Member and member attribute data are then updated at step 360. Updating member and member attribute data may include updating deleted records, new attribute data and other data. Updating member and member attribute data is discussed in more detail below with respect to FIG. 8.

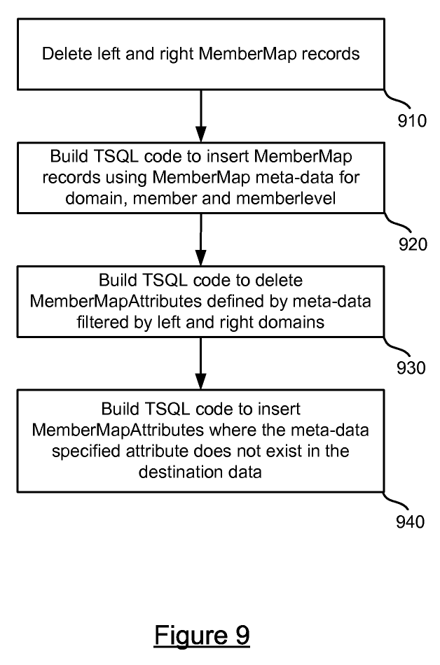

After updating the member and member attribute data, a first member may be mapped to one or more second members based on mapping meta-data, if necessary, at step 370. In some embodiments, there may be no relationships between members. In some embodiments, however, one or more members may be mapped to another member based on mapping data contained in meta-data tables 125. Mapping a first member to one or more second members is discussed in more detail below with respect to FIG. 9. After mapping any members' relationships, a determination is made as to whether more domains from the build member table exist at step 380. Thus, after the first domain is selected at step 310 a determination is made as to whether additional domains exist to be processed. For example, in the build member meta-data table FIG. 10B, a second domain of “geomap” exists to be processed. If no further domains exist in the Build-Member table being processed, the method of FIG. 9 is completed at step 382. If more domains do exist to be processed, the next domain is selected at step 384 and the method of FIG. 3 returns to step 320.

FIG. 4 is a flowchart of an embodiment of a method for determining a Domain Identity. In some embodiments, the method of FIG. 4 proceeds more detail for step 320 of the method of FIG. 3. First, a domain defined in the meta-data tables 125 is selected at step 420. In some embodiments, the selection may be the same selection made at step 310 in the method of FIG. 3. For example, in the meta-data example of FIG. 10B, the domain may be geography. Step 420 of the method of FIG. 4 is optional.

A determination is then made as to whether the selected domain exists in the Domain table of destination tables 135 at step 430. In some embodiments, a query is sent to ODS 130 which contains the Domain table. The query provides the selected domain defined in the meta-data and returns with an indication of whether or not the domain already exists in the domain table. This determination is made in order to retrieve a domain identity value to be used in configuring the Domain table and Members table for member records associated with the particular domain record. If the response to the query indicates that an existing domain record in the table exists, the response will indicate the domain identity of the existing domain record at step 460. The method of FIG. 4 is then completed at step 470. If the selected domain does not exist in the table, ODS 130 will insert the domain contained in the query in a domain table at step 440 and generate a new domain identity. The new domain identity is then provided to ODS data engine 120 by ODS 130 at step 450. In both steps 460 and 450, the domain identity associated with the selected domain may be stored as a variable for future processing. After retrieving the new domain identity value from the table at step 450, the process of FIG. 4 ends at step 470.

FIG. 5 is a flowchart of an embodiment of a method for configuring a DomainAttribute table. In some embodiments, the method of FIG. 5 provides more detail for step 330 of method of FIG. 3. First, a first domain attribute is selected for a selected domain from a BuildMemberMetadata table at step 510. Domain attributes are illustrated in the Domain Attribute table of FIG. 10C. Example domain attributes for a domain of “geography” include location, temperature, and any other data that may describe an attribute of a domain which has several member records. Next, a record is inserted into the domain attribute table to identify the level, domain type, domain source and optionally other data at step 520. The record is inserted for a particular domain ID, such as that retrieved during the method of FIG. 3. Thus, for the particular domain ID, the level and value for an attribute are provided at this step. Next, a level count record is updated of the domain attribute table to reflect the number of levels in the domain, if necessary, at step 530. The level count indicates the number of levels associated with the particular domain. For example, the level count of the domain attribute table of FIG. 10C currently has a value of “4”, indicating that four levels are specified for the particular domain.

A determination is made as to whether additional domain attributes exist to be inserted into the domain attribute table at Step 540. For example, in the domain attribute table of FIG. 10C, attributes have been entered four times. If additional domain attributes exist to be inserted into the domain attribute table from the meta-data tables 125, the next domain attribute is selected from the BuildMember Table of the meta-data tables at step 550 and the method of FIG. 5 returns to step 520. If no additional domain attributes should be inserted, the method of FIG. 5 is complete at step 560.

FIG. 6 is a flowchart of an embodiment of a method for updating a Domain table with retrieved domain data. In some embodiments, the method of FIG. 6 provides more detail for step 340 at the method of FIG. 3. First, member TSQL statements are built from BuildMember meta-data tables at step 610. Thus, TSQL statements are built from the build member data table to build one or more member records. The meta-data in the table is combined by logic contained in ODS data engine 120. The logic may be implemented by one or more stored procedures 122 of data engine 120. A portion of one possible stored procedure for processing domain data and a domain attribute of level is shown below. The below example portion of code can be used to insert Domain Table records.

```
DECLARE
    @DomainName varchar(50)
    ,@LevelName varchar(50)
    ,@LevelNumber varchar(2)
    ,@SourceTable varchar(500)
    ,@CodeColumn varchar(100)
    ,@DescColumn varchar(100)
    ,@ParentColumn varchar(100)
    ,@LevelColumn varchar(100)
    ,@HasMultipleParents bit
    ,@DomainID varchar(2)
    ,@CrLf varchar(12)
    ,@Tab varchar(12)
SET @CrLf = CHAR(10)
SET @Tab = CHAR(9)
DECLARE MetaCursor CURSOR READ_ONLY FOR
  SELECT
    DomainName
    ,LevelName
    ,LevelNumber
    ,SourceTable
    ,CodeColumn
    ,DescColumn
    ,ParentColumn
    ,LevelColumn
    ,HasMultipleParents
  FROM dbo.BuildMember
  WHERE DomainName = COALESCE(@DomainName,DomainName)
    AND IsActive = 1
  ORDER BY SortOrder
OPEN MetaCursor
FETCH NEXT FROM MetaCursor INTO @DomainName,@LevelName,
                @LevelNumber,@SourceTable,@CodeColumn,
                @DescColumn,@ParentColumn,@LevelColumn,
                @HasMultipleParents
WHILE (@@fetch_status <> −1)
BEGIN
  IF (@@fetch_status <> −2)
    BEGIN
    --Handle Domain
      IF EXISTS(SELECT * FROM dbo.Domain
            WHERE DomainName = @DomainName)
        BEGIN
          SELECT @DomainID = DomainID
          FROM dbo.Domain
          WHERE DomainName = @DomainName
        END
      ELSE
        BEGIN
          INSERT INTO Domain (DomainName)
          SELECT @DomainName
          SET @DomainID = scope_identity( )
          END
      RAISERROR(‘--DomainID:%s DomainName:%s LevelName:%s’
      , 0, 1, @DomainID, @DomainName, @LevelName)
      --Handle DomainAttributes ‘Level’
      IF @LevelNumber IS NOT NULL --Only Insert if it is a valid domain
        BEGIN
          IF NOT EXISTS(SELECT * FROM dbo.DomainAttribute
                      WHERE DomainID = @DomainID
                  AND AttributeName = ‘LEVEL0’ + @LevelNumber)
            BEGIN
              RAISERROR(‘--Inserting:%s : LevelNumber:%s LevelName:%s’
              , 0, 1, @DomainID, @LevelNumber, @LevelName)
              INSERT INTO DomainAttribute
              (DomainID, AttributeName, AttributeValue)
              SELECT @DomainID , ‘LEVEL0’ + @LevelNumber, @LevelName
            END
        END
      ELSE
        BEGIN
          RAISERROR(‘--Skipping DomainAttribute Level’,0,1)
        END
  END
  FETCH NEXT FROM MetaCursor
  INTO @DomainName,@LevelName,
    @LevelNumber,@SourceTable,@CodeColumn,
    @DescColumn,@ParentColumn,@LevelColumn,
    @HasMultipleParents
END
CLOSE MetaCursor
DEALLOCATE MetaCursor
```

Execution of the member TSQL statements are then initiated at step 620. Thus, the TSQL statements generated at step 610 are executed at step 620. A portion of example TSQL statements built by a stored procedure for a domain and level name of “area” is provided below. The example output dynamic TSQL code below will insert data into a Member Table. The example portion of output TSQL code below is not necessarily generated from the example portion of code provided above.

```
--DomainID:14 DomainName:Subsidiary LevelName:Area
--Updating DomainAttribute LevelCount:5
--Insert the SourceDomain value IF it does NOT exist for:Subsidiary
--Insert Statement: Code:AreaCode Desc:AreaName Parent:WWBigAreaCd Level:2
Source:FcstWHIN.dbo.SLGE01Area a join FcstWHIN.dbo.SLGE01WWBigArea ba on
ba.WWBigAreaID = a.WWBigAreaID
INSERT INTO MEMBER (DomainID, MemberCode, MemberDesc, MemberParentID,
MemberLevel, Createdate)
SELECT distinct 14 DomainID,
    AreaCode MemberCode,
    AreaName MemberDesc,
    NULLIF(dbo.udfMemberParentID(14,WWBigAreaCd,2),‘NULL’)
MemberParentID,
    2 MemberLevel,
    ‘25 Apr 2007 20:22’ Createdate
FROM FcstWHIN.dbo.SLGE01Area a join FcstWHIN.dbo.SLGE01WWBigArea ba on
ba.WWBigAreaID = a.WWBigAreaID
WHERE 1 = 1 AND AreaCode NOT IN (SELECT MemberCode FROM dbo.Member
where DomainID = 14 and MemberLevel = 2)
ORDER BY AreaCode
--Rows Inserted into Subsidiary.Area = 3
UPDATE m
SET MemberDesc = AreaName,
MemberParentID =NULLIF(dbo.udfMemberParentID(14,WWBigAreaCd,2),‘NULL’)
FROM dbo.Member m
JOIN FcstWHIN.dbo.SLGE01Area a join FcstWHIN.dbo.SLGE01WWBigArea ba on
ba.WWBigAreaID = a.WWBigAreaID ON AreaCode = m.MemberCode
    AND m.DomainID = 14
    AND m.MemberLevel = 2
WHERE m.DomainID = 14
AND m.MemberLevel = 2
AND AreaCode = m.MemberCode
AND (m.MemberDesc <> AreaName
OR ISNULL(m.MemberParentID,“) <>
ISNULL(NULLIF(dbo.udfMemberParentID(14,WWBigAreaCd,2),‘NULL’),”))
--Rows Updated into Subsidiary.Area = 1
DELETE MemberAttribute
FROM MemberAttribute ma
JOIN Member m ON ma.MemberRID = m.MemberRID
WHERE m.domainid = 14
AND ma.attributename = ‘IsDeleted’
AND m.MemberLevel = 2
--Rows removed incase they are back IN source Subsidiary.Area = 0
INSERT MemberAttribute (MemberRID , AttributeName, AttributeValue)
SELECT m.MemberRID, ‘IsDeleted’, ‘1’
FROM dbo.Member m
LEFT JOIN dbo.MemberAttribute ma ON m.MemberRID = ma.MemberRID
WHERE m.membercode IN (
  SELECT xm.membercode FROM dbo.Member xm
  WHERE xm.DomainID = 14
  AND xm.memberlevel = 2
  except
  select convert(varchar(50),AreaCode) from FcstWHIN.dbo.SLGE01Area a join
FcstWHIN.dbo.SLGE01WWBigArea ba on ba.WWBigAreaID = a.WWBigAreaID)
  AND m.DomainID = 14
  AND m.MemberLevel = 2
  AND ma.AttributeName IS NULL
--Rows marked IsDeleted for Subsidiary.Area = 0
```

The example output TSQL code above includes a user defined function dbo.udfMemberParentID( ). The user defined function (udf) named dbo.udfMemberParentID (@DomainID, @MemberCode, @MemberLevel) is used to retrieve the ParentMemberID for the record being inserted. In some embodiments, the function can take parameters of DomainID, MemberCode and MemberLevel. The return value is the actual MemberRID for the record that is the parent of the record being inserted. The function may return the MemberRID of the Member Table where the passed parameter values (for example, DomainID, MemberCode and MemberLevel parameter values) are equal to the respective values of the Member table. If no values match the parent record that is queried, the function may returns NULL

Execution of the member TSQL statements results in sending a member data query to data source 110 by ODS data engine 120 at step 630. In some embodiments, the query is sent as a TSQL statement from ODS data engine 120 to data store 110. Data store 110 receives the query, retrieves source data 105 corresponding to the query, and sends the source data back to ODS data engine 120.

Source data is received from data store 110 by ODS data engine 120 at step 640. Member data in a member table of destination table 135 is then updated with the received data at step 650. In some embodiments, ODS data engine 120 compares the received data from data store 110 to data in one or more destination tables. If the received data is not contained in the corresponding destination table, the received data is inserted into the table. If the data is contained in the table, the levels, descriptions, and other data associated with each domain record and member record are compared. If the dimension table data differs, it is replaced with the data retrieved from data store 110.

FIG. 7 is a flowchart of an embodiment of a method for updating a domain attribute table with retrieved domain attribute data. In some embodiments, the method of FIG. 7 provides more detail for step 350 in the method of FIG. 3. The method of FIG. 7 updates domain attribute table in a manner similar to that in which the domain table was updated in the method of FIG. 6. Thus, step 710-750 are similar to step 610-650 of the method of FIG. 6. First, member attribute TSQL statements are built from BuildMemberAttribute meta-data tables at step 710. Next, execution of the member attribute TSQL statements are initiated at step 720.

A member attribute data query is sent to data store 110 by ODS data engine 120 at step 730. The query is received by data store 110, processed, and source data 105 which matches the query is sent by data store 110 to ODS data engine 124. The member attribute data matching the query is received from data store 110 by ODS data engine 120 at step 740. The data in the MemberAttribute table of the destination tables 135 is then updated with the received data at step 750.

FIG. 8 is a flowchart of an embodiment of a method for updating member and member attribute data. In some embodiments, member records and member record attributes may be updated when the corresponding member data in data store 110 is updated, deleted or replaced. In some embodiments, the method of FIG. 8 provides more detail for step 360 of the method of FIG. 3. First, member attributes in the member attributes table which have been deleted at the source data are updated at step 810. In some embodiments, the code will update member attributes where the attribute name equals “is deleted=1” or “is deleted=0”, where the member record is now active or has been reinserted from the source.

Member records are then updated with a soft delete in a member table but have been deleted at the source data at step 820. These members are soft deleted by setting a parameter associated with the particular records rather than physically deleting the data. This insures that the data may be recovered easily if the deletion was in error or is temporary. Next, member records with new member specific attributes are updated at step 830. Member attributes that did not previously exist in the member attribute table are then inserted at step 840. Finally, member attribute records that have changed since the last query to the source data are updated at step 850. Updating the member attributes may include comparing the attributes, inserting the attribute data that did not previously exist in the records data, and changing attribute values and other data for attributes that have changed since the last update.

FIG. 9 is a flowchart an embodiment of a method for mapping relationships between members. In some embodiments, FIG. 9 provides more detail for step 370 of the method of FIG. 3. First, the left and right member map records are deleted at step 910. Next, TSQL code is built to insert member map records using member map meta-data for domain, member and member level data at step 920. Next, TSQL code is built to delete member map attributes defined by meta-data filtered by left and right domains at step 930. TSQL code is then built to insert member map attributes where the meta-data specified attribute does not exist in the dimension data at step 940. The generated TSQL code statements are then executed to insert member map records, delete the appropriate member map attributes and insert the member map attributes that are not already present.

FIG. 10A is an example of sample values for a source table of domain and member data and mapping data. The source domain and member data table contain columns of Geocode, GeoParent, GeoLevel, GeoDescription and LocalCurrency. The source mapping table contains columns of GeoGroupCode, GeoGroupDescription, GeoCode and TransCurrency. This source data can be accessed by TSQL code generated from the meta-data in the tables of FIG. 10B and is placed in the destination tables of FIG. 10C.

FIG. 10B illustrates sample values for meta-data tables 125. The sample values can be used to generate TSQL code statements which query data store 110 for the source data of the tables of FIG. 10A. For example, the Domain name column in the BuildMember meta-data table lists domains of Geography and GeoMap, corresponding to the two source tables of FIG. 10A, and code columns GeoCode and GeoGroupCode which correspond to columns in the source tables.

FIG. 10C provides example values for data contained in destination tables 135. The example data in destination tables 135 is retrieved from the source tables of FIG. 10A by code generated from the meta-data contained in the tables of FIG. 10B. For example, the two domains listed in the domain table of FIG. 10C are the domains corresponding to the two source tables of FIG. 10A.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A computer implemented method for transferring data, comprising:
accessing meta-data which describes remote source data provided by an enterprise hierarchy system;
dynamically generating query code by combining the accessed meta-data;
executing the query code to retrieve the remote source data from the enterprise hierarchy system, the remote source data stored in a first format at a remote data store; and
storing the retrieved source data in a set of destination tables having a second format, the second format based on a set of domain records, a set of member records for each domain record, and attributes for each domain record and member record.

2. The computer implemented method of claim 1, wherein said step of accessing includes:
retrieving meta-data from one or more meta-data tables by a stored procedure, the stored procedure configured to generate TSQL query code form the meta-data.

3. The computer implemented method of claim 1, wherein said step of accessing includes:
retrieving meta-data from one or more meta-data tables having a single schema by a stored procedure, the stored procedure configured to query two or more data sources based on data contained in the meta-data tables having the single schema.

4. The computer implemented method of claim 1, wherein dynamically generating query code includes:
selecting a domain from the meta-data;
determining a domain identity value for the selected domain;
configuring one or more member records for the domain identity in the destination tables from the meta-data; and
constructing one or more TSQL statements by concatenating the meta-data associated with the selected domain and one or more member records.

5. The computer implemented method of claim 1, wherein generating the query code includes concatenating the accessed meta-data into one or more queries, wherein each query includes the location of the source data, the location of the source data derived from the accessed set of meta-data.

6. The computer implemented method of claim 1, further comprising:
configuring the set of destination tables by a stored procedure, the set of destination tables configured to include domain, member and mapping data described in the accessed meta-data.

7. The computer implemented method of claim 1, wherein said step of storing includes:
determining whether to insert the source data as a new record or update an existing record in the destination tables.

8. The computer implemented method of claim 1, wherein said step of storing includes:
storing the source data as an attribute for a domain record, member record or mapping data;

9. The computer implemented method of claim 1, wherein said step of storing includes:
saving relationship data associated with two or more members, the relationship data generating a mapped relationship between the two or more members.

10. The computer implemented method of claim 1, wherein said step of storing includes:
determining a selected member record has been deleted in the source data; and
setting a parameter for the selected member record to indicate that the member record is to be considered deleted without deleting the selected member record.

11. The computer implemented method of claim 1, wherein the second format is also based on member mapping data contained in one or more member mapping tables within the destination tables.

12. An apparatus for transferring data, comprising:
a communication interface;
a storage device containing one or more meta-data tables, the meta-data tables having meta-data describing domain, member, member mapping and attribute data; and
one or more processors in communication with said storage device and said communication interface, said one or more processors implementing a data engine,
the data engine configured to build transact-SQL (TSQL) statements for accessing remote source data and store the accessed source data in one or more destination tables, the engine configured to build the TSQL statements based on the meta-data in said meta-data tables.

13. The apparatus of claim 12, wherein the destination tables include a domain table, member table, member map table, and attribute tables.

14. The apparatus of claim 12, the data engine including logic that configures the destination tables and updates the destination tables with accessed source data.

15. The apparatus of claim 12, the data engine including logic that constructs the TSQL statements by concatenating the meta-data in the meta-data tables.

16. The apparatus of claim 12, the data engine including a first stored procedure that builds destination tables containing domain and member records and a second stored procedure that creates relationships between member records in the destination tables.

17. One or more processor readable storage devices having processor readable code embodied on said processor readable storage devices, said processor readable code for programming one or more processors to perform a method comprising:
accessing meta-data which describes remote source data at a first data store having a first schema and a second data store having a second schema;
dynamically generating code statements by a data engine by combining the accessed meta-data;
executing the code statements to retrieve the remote source data from the first data store and the second data store;
determining if the retrieved source data is different from stored data in two or more destination tables; and
updating the two or more destination tables based on the step of determining if the retrieved source data is different,
said step of updating including storing the retrieved source data from the first data store and the second data store in the two or more destination tables, the two or more destination tables having a third schema based domain records, member records for each domain record, and attributes for each domain record and member record.

18. The one or more processor readable storage devices of claim 17, further comprising:
updating the meta-data to include source data at a third data store;
dynamically generating additional code statements to retrieve the source data at the third data store;
executing the additional code statements to retrieve the source data from the third data store; and
storing the source data from the third data store in the destination tables along with the source data from the first data store and the second data store.

19. The one or more processor readable storage devices of claim 17, wherein said step of updating includes:
determining whether a member record should be inserted, soft-deleted or updated in the destination tables.

20. The one or more processor readable storage devices of claim 17, wherein said step of updating includes:
storing mapping data which indicates a relationship between a first member record and one or more second member records.
